(19) United States
(12) Patent Application Publication
(10) Pub. No.: US 2012/0236805 A1
(43) Pub. Date: Sep. 20, 2012

(54) METHOD AND APPARATUS FOR PROVIDING INFORMATION TO DETERMINE A CAUSE OF LOW QUALITY OF SERVICE IN A WIRELESS COMMUNICATION SYSTEM

(75) Inventors: Richard Lee-Chee Kuo, Taipei (TW); Yu-Hsuan Guo, Taipei (TW)

(73) Assignee: INNOVATIVE SONIC CORPORATION, Taipei (TW)

(21) Appl. No.: 13/418,897

(22) Filed: Mar. 13, 2012

Related U.S. Application Data
(60) Provisional application No. 61/452,563, filed on Mar. 14, 2011.

(51) Int. Cl. H04W 72/04

(52) U.S. Cl. 370/329

(57) ABSTRACT

A method and apparatus for providing information to determine a cause of low Quality of Service (QoS) includes Scheduling Request (SR) transmission status reporting or reporting uplink power for SR transmission. The SR transmission status reporting includes a User Equipment (UE) being configured with Physical Uplink Control Channel (PUCCH) resource for SR transmission, and the UE reporting SR transmission status information to a connecting eNB. The reporting of uplink power for SR transmission includes a UE being configured with a PUCCH resource for SR transmission; and the UE reporting uplink power information for SR transmission to a connecting eNB.

### CROSS-REFERENCE TO RELATED APPLICATIONS

The present application claims the benefit of U.S. Provisional Patent Application Ser. No. 61/452,563, filed on Mar. 14, 2011, the entire disclosure of which is incorporated herein by reference.

### FIELD

This disclosure generally relates to wireless communication networks, and more particularly, to a method and apparatus for providing information to determine a cause of low Quality of Service (QoS) in a wireless communication system

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

According to one aspect, a method for providing information to determine a cause of low Quality of Service (QoS) includes a User Equipment (UE) being configured with Physical Uplink Control Channel (PUCCH) resource for scheduling request (SR) transmission, and the UE reporting SR transmission status information to a connecting eNB.

According to another aspect, a communication device for use in a wireless communication system includes a control circuit, a processor installed in the control circuit for executing a program code to command the control circuit, and a memory installed in the control circuit and coupled to the processor. The processor is configured to execute a program code stored in memory to provide information for determining a cause of low QoS by the communication device being configured with PUCCH resource for SR transmission, and reporting SR transmission status information to a connecting eNB.

According to another aspect, a method for providing information to determine a cause of low QoS includes a UE being configured with PUCCH resource for SR transmission, and the UE reporting uplink power information for SR transmission to a connecting eNB.

According to another aspect, a communication device for use in a wireless communication system includes a control circuit, a processor installed in the control circuit for executing a program code to command the control circuit, and a memory installed in the control circuit and coupled to the processor. The processor is configured to execute a program code stored in memory to provide information for determining a cause of low QoS by the communication device being configured with PUCCH resource for SR transmission, and the communication device reporting uplink power information for SR transmission to a connecting eNB.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3.

FIG. 5 is a block diagram of a method according to one embodiment.

FIG. 6 is a block diagram of a method according to another embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced), 3GPP2 UMB (Ultra Mobile Broadband). WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 3GPP TS 36.331, V.10.0.0 (“Evolved Universal Terrestrial Radio Access (E-UTRA); Radio Resource Control (RRC) protocol specification (Release 1.0)”); 3GPP TS 36.321, V.10.0.0 (“Evolved Universal Terrestrial Radio Access (E-UTRA); Medium Access Control (MAC) protocol specification (Release 10)”); IR 36.805-900. “Study on Minimization of drive-tests in Next Generation Networks (Release 9)”; and RP-10xxxx. “MDT WID Rel-11 Core v06”. The standards and documents listed above are hereby expressly incorporated herein.

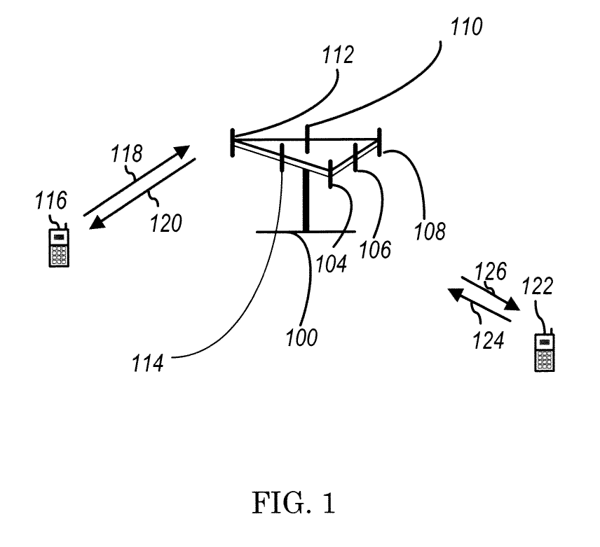

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, abuse station, an enhanced base station, an eNodeB, or some other terminology. An access terminal (AT) may also be called user equipment (CE), a wireless communication device, terminal, access terminal or some other terminology.

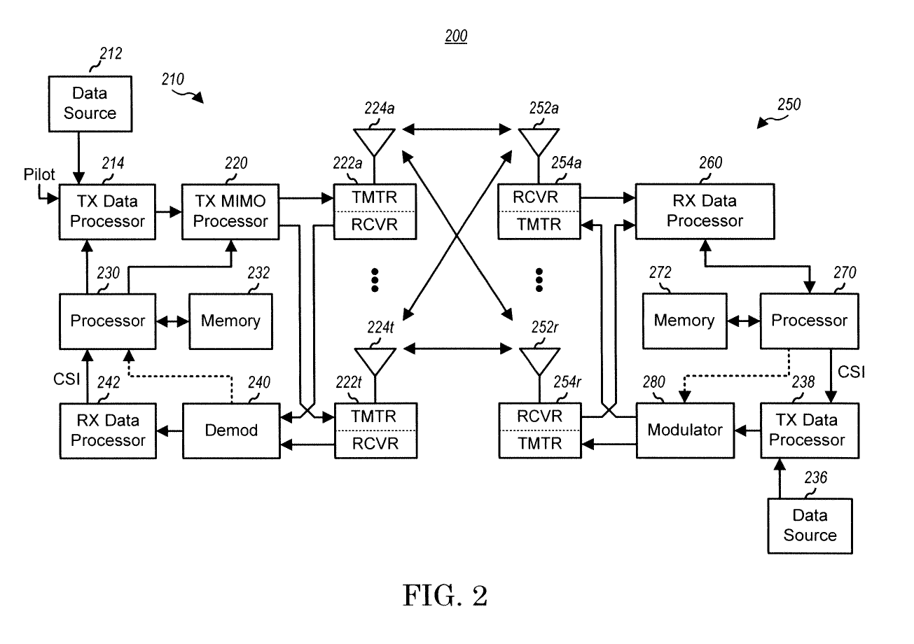

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TN) data processor 214.

In one embodiment, each data stream is transmitted over a respective transmit antenna, TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g. for OFDM). TX MIMO processor 220 then provides N_{T} modulation symbol streams to N_{T} transmitters (TMTR) 222a through 2221. In certain embodiments. TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 274a through 224t, respectively.

At receiver system 250, the transmitted modulated signals are received by N_{R} antennas 752a through 252r and the received signal from each antenna 252 is provided to a respective receiver (RCVR) 254a through 254r. Each receiver 254 conditions e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

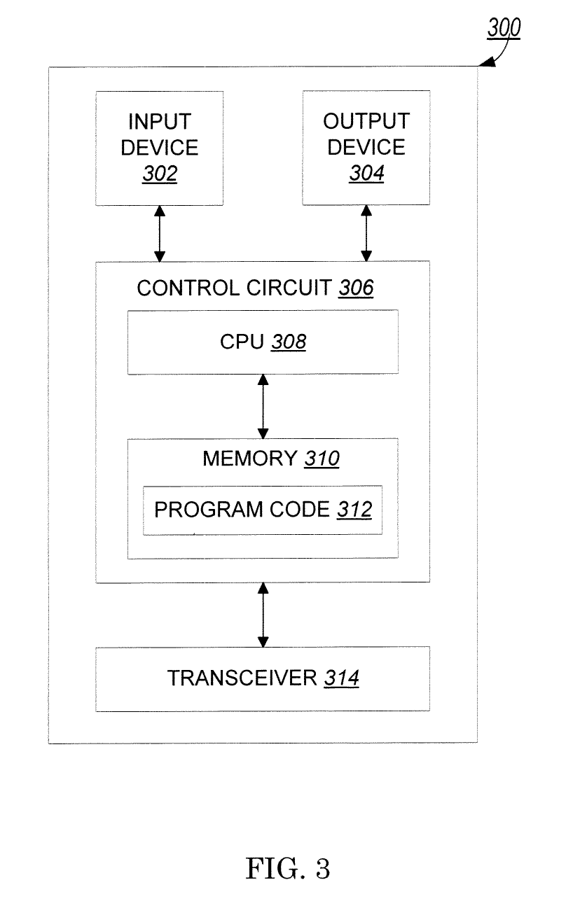

Turning to FIG. 3, this fig in shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

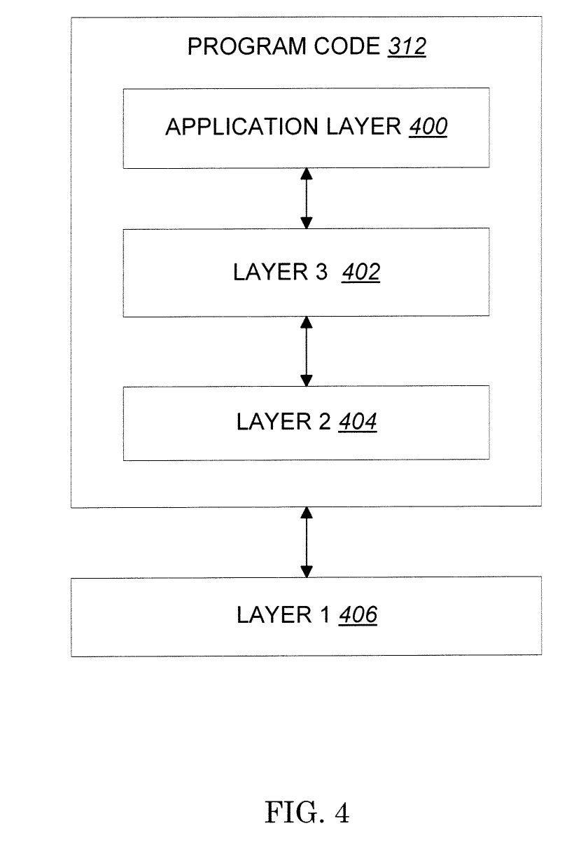

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Reasons for an unexpectedly low Quality of Service (QoS) may be different. For example, coverage, load or user mobility may negatively affect QoS. Certain propagation conditions or uneven traffic distribution may also negatively affect QoS at the border region of several cells or localized in the cell. Only looking at cell level statistics may not be an effective way to understand the origin of the problem and take the appropriate actions (e.g. whether to increase the coverage, the capacity or to change the RRM settings). Packet transfer delay is an important metric of QoS to be verified. Thus, factors which may cause delay to packet transfer should be collected for cause analysis in case a low QoS occurs.

When new uplink data arrive in a UE, typically a scheduling request (SR) procedure is used for requesting uplink resources for new data transmissions. An SR procedure is performed using Physical Uplink Control Channel (PUCCH) resource configured to the UE. If the parameter settings of the PUCCH are not proper for the UE at the current location, the SR signaling may encounter difficulty in reaching the eNB, which could cause delay to the subsequent data transmissions. Thus, as described in detail below, it may be beneficial for a UE to report the SR transmission status to eNB for cause analysis in case a low QoS occurs.

A good indication of SR transmission status is the number of SRs sent by the UE for the previous SR procedure. A large number of SRs sent by the UE may imply poor PUCCH parameter settings, which may need to be adapted accordingly to remedy the situation. A UE may also report a list of SR numbers sent for a certain number of previous SR procedures. For example, one SR number can be reported per SR procedure.

An alternative to reporting the number of SRs by the UE could be the UE sending the average number of SRs sent by the UE for the previous SR procedures performed within a certain time period. For example, the UE can send the average number of SRs sent by the UE for the previous SR procedures performed within a sliding window. A yet another alternative may be to send the average number of SRs sent by the UE over a certain number of previous SR procedures. The above discussed SR procedures may refer to a successfully completed SR procedure.

A UE can report the SR transmission status to eNB in two possible ways. One way is for the UE to report SR transmission status when a long uplink packet transfer delay is detected in the UE. Another way is for the eNB to request the UE to report the SR transmission status when a long uplink packet transfer delay is detected in the eNB. The eNB may request UE to report the SR transmission status via a UE Information Request message and the UE may report the SR transmission status via a UE Information Response message.

Packet transfer delay calculation can be facilitated by attaching a time stamp to each packet so that the receiving side can calculate the transfer delay based an time difference. However, the noted packet transfer delay calculation may induce excessive resource overhead. A more simple method would be for a UE to report the number of SRs sent for an SR procedure if the number of sent SRs is greater than a threshold. In addition to the SR transmission status, time stamp and location information of the FT may also be reported to the eNB.

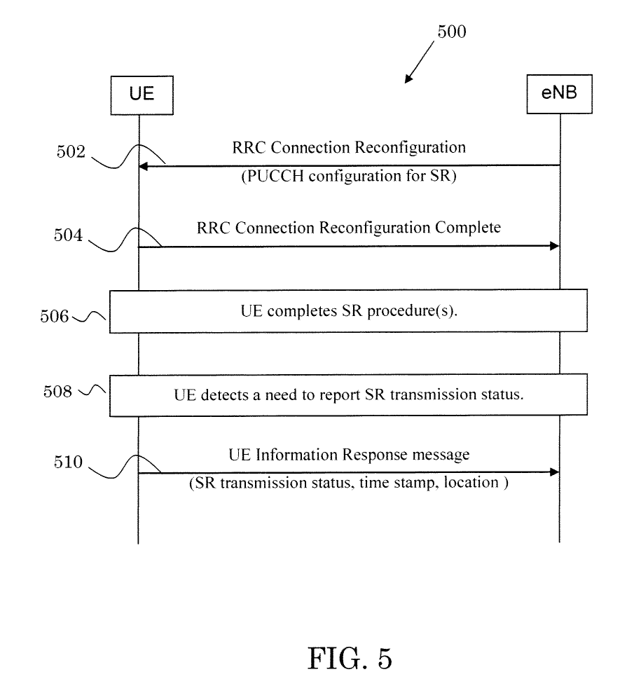

Referring to FIG. 5, an exemplary method 500 for reporting scheduling request transmission status information for QoS verification is shown. The method 500 generally includes a UE being configured with PUCCH resource for SR transmission; and the UE reporting SR transmission status information to a connecting eNB. The method 500 in detail may include at 502, a Radio Resource Control (RRC) Connection Reconfiguration message being sent to the UE from the eNB to configure the UE with PUCCH resource for SR transmission. At 504, the UE sends a message to notify the eNB that the connection reconfiguration is complete. At 506, the UE completes the SR procedure(s). The SR procedure refers to a successfully completed SR procedure. The SR procedure is used tOr requesting uplink resources for new data transmissions. At 508, the UE detects a need to report SR transmission status. As described above, the need to report SR transmission status may arise when a long uplink packet transfer delay is detected in the UE or the eNB. In case the delay is detected by the eNB, the UE may receive a request message from the eNB to report the SR transmission status. Alternatively, the need may arise if the number of sent SRs is greater than a threshold. At 510, the UE sends an UE Information Response message to the eNB, by which the UE provides at least the SR transmission status.

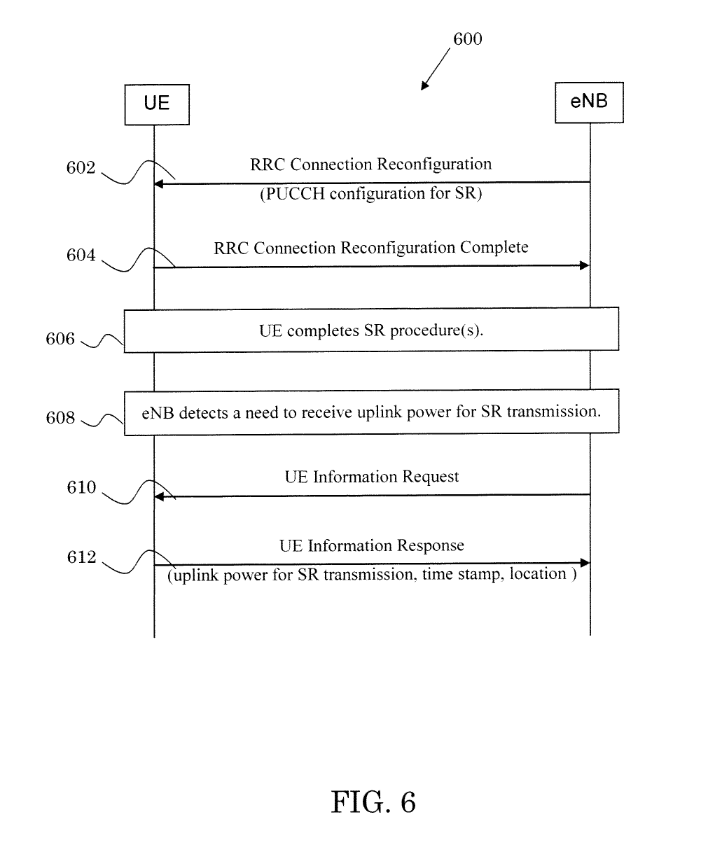

The uplink power used for SR transmission may also be useful for cause analysis in case a low QoS occurs. Accordingly, FIG. 6 shows an exemplary method for reporting uplink power information for scheduling request transmission for QoS verification. The method 600 generally includes a UE being configured with PUCCH resource for SR transmission; and the UE reporting uplink power information for SR transmission to a connecting eNB. The method 600 in detail may include at 602, a Radio Resource Control (RRC) Connection Reconfiguration message being sent to the UE from the eNB to configure the UE with PUCCH resource for SR transmission. At 604, the UE sends a message to notify the eNB that the connection reconfiguration is complete. At 606, the UE completes the SR procedure(s). The SR procedure refers to a successfully completed SR procedure. The SR procedure is used for requesting uplink resources for new data transmissions. At 608, the eNB detects a need to receive uplink power information for SR transmission. As described above, the need to report uplink power information for SR transmission may arise when a long uplink packet transfer delay is detected in the UE or the eNB. Alternatively, the need may arise if the number of sent SRs is greater than a threshold. At 610, the eNB sends an UE Information Request message to the UE. At 612, the UE sends an UE Information Response message to the eNB, by which the UE provides uplink per information for SR transmission to the eNB. The UE may also report SR transmission status information to the eNB with the UE Information Response message. The uplink power information refers to information to indicate the power for transmitting the last SR during the last SR procedure. The uplink power information may contain a list of information to indicate uplink powers for transmitting the last SRs during the certain number of previous SR, procedures. The uplink power information may also refer to information to indicate the average power of those powers for transmitting the last SRs during the previous SR procedures.

The SR transmission status information may contain the number of SRs sent during the previous SR procedure. The SR transmission status information may contain a list of SR numbers sent during a certain number of previous SR procedures. The certain number may be a predefined value or may be configured by the eNB. The SR transmission status information may contain the average number of SRs sent during a certain number of previous SR procedures. The SR transmission status information may contain the average number of SRs sent during the previous SR procedures performed within a certain time period (e.g. calculated within a sliding window). The time period may be a predefined value or may be configured by eNB,

The SR transmission status information may be reported when a long uplink packet transfer delay is detected in UE. The SR transmission status information may be reported when the number of SRs sent during the previous SR procedure is greater than a threshold. The threshold may be a predefined value or configured by the eNB. The SR transmission status information may be reported in response to reception of a request from the eNB.

The UE may also report a time stamp with the Information Response message. The time stamp may indicate the time of sending the last SR during the previous SR procedure(s). The SR transmission status information may contain a list of time stamps, with each time stamp indicating the time of sending the last SR during each SR procedure of the certain number previous SR procedures.

The UE may also report location information of the UE with the Information Response message. The location information may indicate the UE location and/or velocity at the time of sending the last SR during the previous SR procedure(s). The SR transmission status information may contain a list of location information, with the location information indicating the UE location and/or velocity at the time of sending the last SR during each SR procedure of the certain number previous SR procedures.

Referring back to FIGS. 3 and 4, the UE 300 includes a program code 312 stored in memory 310. The CPU 308 can execute the program code 312 to configure a UE with PUCCH resource for SR transmission, and have the UE report SR transmission status information to a connecting eNB. The CPU 308 can also execute the program code 312 to have the UE report uplink power information for SR transmission to a connecting eNB. The CPU 308 can also execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (NVIncli may be referred to herein, for convenience, as a “processor”) such the processor can read information code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing information to determine a cause of low Quality of Service (QoS), comprising:
a User Equipment (UE) being configured with Physical Uplink Control Channel (PUCCH) resource for scheduling request (SR) transmission; and
the UE reporting SR transmission status information to a connecting eNB.

2. The method of claim 1, wherein the SR transmission status information comprises at least one of:
a number of SRs sent during a previous SR procedure;
a list of SR numbers sent during a certain number of previous SR procedures;
an average number of SRs sent during a certain number of previous SR procedures;
an average number of SRs sent during previous SR procedures performed within a certain time period;
a time stamp indicating a time of sending a last SR during a previous SR procedure;
a list of time stamps, each time stamp indicating a time of sending the last SR during each SR procedure of the certain number previous SR procedures;
location information of the UE; and
a list of location information of the UE.

3. The method of claim 2, wherein the location information indicates at least one of the UE location and velocity at a time of sending the last SR during the previous SR procedure.

4. The method of claim 2, wherein each location information on the list of location information indicates at least one of the UE location and velocity at a time of sending the last SR during each SR procedure of the certain number previous SR procedures,

5. The method of claim 1, wherein SR transmission status information is reported:
when a long uplink packet transfer delay is detected in the UE;
when a number of SRs sent during a previous SR procedure is greater than a threshold; or
in response to reception of a request from the eNB.

6. A communication device for use in a wireless communication system the communication device comprising:
a control circuit;
a processor installed in the control circuit for executing a program code to command the control circuit; and
a memory installed in the control circuit and coupled to the processor;
wherein the processor is configured to execute a program code stored in memory to provide information for determining a cause of low Quality of Service (QoS) by:
the communication device being configured with Physical Uplink Control Channel (PUCCH) resource for scheduling request (SR) transmission; and
reporting SR transmission status information to a connecting eNB.

7. The communication device of claim 6, wherein the SR transmission status information comprises at least one of:
a number of SRs sent during a previous SR procedure;
a list of SR numbers sent during a certain number of previous SR procedures;
an average number of SRs sent during a certain number of previous SR procedures;
an average number of SRs sent during previous SR procedures performed within a certain time period;
a time stamp indicating a time of sending a last SR during a previous SR procedure;
a list of time stamps, each time stamp indicating a time of sending the last SR during each SR procedure of the certain number previous SR procedures;
location information of the UE; and
a list of location information of the UE.

8. The communication device of claim 7, wherein the location information indicates at least one of the UE location and velocity at a time of sending the last SR during the previous SR procedure.

9. The communication device of claim 7, wherein each location information on the list of location information indicates at least one of the UE location and velocity at a time of sending the last SR during each SR procedure of the certain number previous SR procedures.

10. The communication device of claim 6, wherein the SR transmission status information is reported:
when a long uplink packet transfer delay is detected in the UE;
when a number of SRs sent during a previous SR procedure is greater than a threshold; or
in response to reception of a request from the eNB.

11. A method for providing information to determine a cause of low Quality of Service (QoS) comprising:
a User Equipment (UE) being configured with Physical Uplink Control Channel (PUCCH) resource for scheduling request (SR) transmission; and
the UE reporting uplink power information for SR transmission to a connecting eNB.

12. The method of claim 11, wherein the uplink power information refers to information to indicate power for transmitting a last SR during a last SR procedure.

13. The method of claim 11, wherein the uplink power information contains a list of information to indicate uplink powers for transmitting a last SRs during a certain number of previous SR procedures.

14. The method of claim 11, wherein the uplink power information refers to information to indicate average power of powers for transmitting a last SRs during a previous SR procedures.

15. The method of claim 11, wherein the uplink power information for SR transmission is reported:
when a long uplink packet transfer delay is detected in the UE;
when a number of SRs sent during a previous SR procedure is greater than a threshold; or
in response to reception of a request from the eNB.

16. A communication device for use in a wireless communication system, the communication device comprising:
a control circuit;
a processor installed in the control circuit for executing a program code to command the control circuit; and
a memory installed in the control circuit and coupled to the processor;
wherein the processor is configured to execute a program code stored in memory to provide information for determining a cause of low Quality of Service (QoS) by:
the communication device being configured with Physical Uplink Control Channel (PUCCH) resource for scheduling request (SR) transmission; and
the communication device reporting uplink power information for SR transmission to a connecting eNB.

17. The communication device of claim 16, wherein the uplink power information refers to information to indicate power for transmitting a last SR during a last SR procedure.

18. The communication device of claim 16, wherein the uplink power information contains a list of information to indicate uplink powers for transmitting a last SRs during a certain number of previous SR procedures.

19. The communication device of claim 16, wherein the uplink power information refers to information to indicate average power of powers for transmitting a last SRs during a previous SR procedures.

20. The communication device of claim 16, wherein the uplink power information for SR transmission is reported:
when a long uplink packet transfer delay is detected in the UE;
when a number of SRs sent during a previous SR procedure is greater than a threshold; or
in response to reception of a request from the eNB.
